(19) United States
(12) Patent Application Publication
(10) Pub. No.: US 2020/0174152 A1
(43) Pub. Date: Jun. 4, 2020

(54) EVALUATION OF FORMATION FRACTURE PROPERTIES USING NUCLEAR MAGNETIC RESONANCE

(71) Applicants: Hasan Kesserwan, Al-Khobar (SA); Guodong Jin, Kathy, TX (US)

(72) Inventors: Hasan Kesserwan, Al-Khobar (SA); Guodong Jin, Kathy, TX (US)

(73) Assignee: Baker Hughes, a GE company, LLC, Houston, TX (US)

(21) Appl. No.: 16/205,353

(22) Filed: Nov. 30, 2018

(51) Int. Cl. G01V 3/32; G01V 3/38

(52) U.S. Cl. CPC G01V 3/32; G01V 3/38

(57) ABSTRACT

An apparatus for estimating fracture properties of a resource bearing formation includes a nuclear magnetic resonance (NMR) measurement device configured to be deployed in a region of interest including a tight rock formation region, the NMR measurement device including a transmitting assembly configured to transmit an NMR pulse sequence into the tight rock formation region, a receiving assembly configured to detect NMR signals corresponding to a response of the formation region to the pulse sequence, and a processor configured to receive the NMR signals. The processor is configured to invert the NMR signals into a transverse relaxation time (T₂) distribution, separate the T₂ distribution based on a cut-off time into a first volumetric indicative of matrix and pore responses and a second volumetric indicative of fracture responses, estimate a pore size distribution based on the second volumetric, and calculate a fracture aperture size distribution based on the pore diameter.

### BACKGROUND

Understanding the characteristics of geologic formations and fluids located therein is important for effective hydrocarbon exploration and production. Operations such as drilling, formation evaluation and production rely on accurate petrophysical interpretation derived from a diverse set of logging technologies.

Properties of fractures in formations can be useful in evaluating characteristics of a formation, such as potential hydrocarbon content. For example, fractured reservoir layers can be indicative of productive zones in a formation. Formation regions having high fracture density and/or high fracture apertures may indicate the presence of a sweet spot or high permeability zone.

### SUMMARY

An embodiment of an apparatus for estimating fracture properties of a resource bearing formation, the apparatus includes a nuclear magnetic resonance (NMR) measurement device configured to be deployed in a region of interest, the region of interest including a tight rock formation region, the NMR measurement device including a transmitting assembly configured to transmit an NMR pulse sequence into the tight rock formation region, and a receiving assembly configured to detect NMR signals corresponding to a response of the tight rock formation region to the pulse sequence; and a processor configured to receive the NMR signals and perform: inverting the NMR signals into a transverse relaxation time (T₂) distribution; separating the T₂ distribution based on a cut-off time into a first volumetric indicative of matrix and pore responses and a second volumetric indicative of fracture responses; estimating a pore size distribution based on the second volumetric; and calculating a fracture aperture size distribution based on the pore diameter.

An embodiment of a method of estimating fracture properties of a resource bearing formation, the method including receiving, by a processor, NMR signals generated by a nuclear magnetic resonance (NMR) measurement device deployed in a region of interest, the region of interest including a tight rock formation region, the NMR measurement device including a transmitting assembly configured to transmit an NMR pulse sequence into the tight rock formation region, and a receiving assembly configured to detect NMR signals corresponding to a response of the tight rock formation region to the pulse sequence; and inverting the NMR signals into a transverse relaxation time (T₂) distribution; separating the T₂ distribution based on a cut-off time into a first volumetric indicative of matrix and pore responses and a second volumetric indicative of fracture responses; estimating a pore size distribution based on the second volumetric; and calculating a fracture aperture size distribution based on the pore diameter.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts an embodiment of a drilling and formation measurement system that includes a nuclear magnetic resonance (NMR) measurement device;

FIG. 2 is a flow chart that depicts an embodiment of a method of performing NMR measurements and estimating fracture properties of a formation region;

FIG. 3 depicts an example of a T₂ distribution derived from NMR measurements and a selected cut-off time associated with responses of fractures in a formation; and

FIG. 4 depicts an example of a fracture aperture distribution calculated based on the T₂ distribution of FIG. 1 according to one or more embodiments.

### DETAILED DESCRIPTION

Methods, systems and apparatuses for calculating or estimating fracture properties of resource bearing formations using magnetic resonance techniques are described herein. Systems and methods are provided for estimating or calculating fracture aperture sizes (e.g., estimating a fracture aperture size distribution) in a tight rock formation region, based on pore size data derived from a T₂ distribution.

In one embodiment, calculation of fracture aperture size is performed by separating a T₂ distribution using a cut-off time that is selected to separate the T₂ response of a region into a first T₂ distribution portion that is indicative of matrix and pore responses, and a second T₂ distribution portion that is indicative of fracture responses. For example, the cut-off time is calculated based on a maximum pore size and a maximum surface relaxivity for a given tight rock formation. The maximum pore size and maximum surface relaxivity may be selected based on, e.g., previous measurements and/or knowledge of the makeup of the tight rock formation or a similar formation. The second T₂ distribution portion (which is indicative of fracture responses) can be analyzed to determine a pore size distribution, and a fracture aperture size distribution can be estimated based on a direct correlation between pore size and fracture aperture.

Embodiments described herein provide a number of advantages and technical effects. For example, the embodiments provide an effective technique for determining the existence of fractures and estimating fracture properties, which can be used to evaluate the potential of a formation to produce hydrocarbons. Fractured reservoir layers can be indicators of potential sweet spots and identified as productive zones. In addition, the embodiments provide a method that is relatively simple and straightforward, and allows for fracture property assessment using available tools and without requiring significant additional processing resources, by providing a direct correlation between pore size and fracture aperture.

Fracture aperture size data can be used in a variety of ways, e.g., to plan, monitor and/or control an energy industry operation. For example, the methods and systems may be used to provide real time assessment of reservoir quality by providing information on the fracture properties of a formation or formation region. In another example, an energy industry operation such as a drilling or stimulation operation can be planned and controlled based on fracture aperture size data.

Knowledge of fracture sizes and distribution gained from the embodiments described herein can affect drilling and completion strategies. For example, open fractures can lead to drilling fluid losses and increased costs. This knowledge can be utilized to avoid such open fractures or adjust operational plans to mitigate fluid losses.

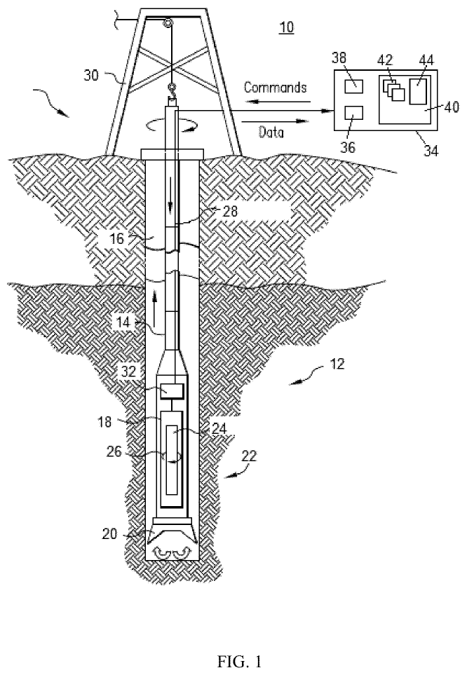

FIG. 1 illustrates an exemplary embodiment of a drilling and/or measurement system 10 that includes devices or systems for in-situ measurement of characteristics of a resource bearing formation 12. The system 10 includes a borehole string 14 (or simply “string”) configured to be deployed in a borehole 16 that extends through the formation 12. In one embodiment, the formation 12 is a tight rock formation and/or includes one or more zones or regions characterized as tight rock zones or regions.

The system 10 includes a magnetic resonance device such as an NMR tool 18. The tool 18 is configured to generate magnetic resonance data for use in estimating fracture characteristics of a formation, and/or other characteristics such as porosity, pore size, irreducible water saturation, permeability, hydrocarbon content, fluid viscosity and others. The tool 18 may be configured as a component of various subterranean systems, such as wireline well logging and logging-while-drilling (LWD) systems.

In the embodiment of FIG. 1, the borehole string 14 is a drill string 14 that includes, e.g., a plurality of pipe sections and a drill bit 20. The tool 18 can be incorporated within the drill string 14, for example in a bottomhole assembly (BHA) 22, during a drilling operation or LWD operation.

The NMR tool 18 includes a static magnetic field source 24, such as a permanent magnet assembly, that magnetizes formation materials and a transmitter and/or receiver assembly 26 (e.g., an antenna or antenna assembly) that transmits radio frequency (RF) energy or pulsed energy that provides an oscillating magnetic field in the formation, and detects NMR signals as voltages induced in the receiver. The assembly 26 may serve the receive function, or distinct receiving antennas may be used for that purpose.

In one embodiment, the NMR tool 18 and/or other downhole components are equipped with transmission equipment to communicate with other downhole components and/or with surface devices or components. For example, transmission equipment such as a cable 28 extends from the BHA 22 to surface equipment such as a drill rig 30. The transmission equipment may take any desired form, and different transmission media and methods may be used, such as wired, fiber optic, mud pulse telemetry and/or other wireless transmission methods.

The cable 28 or other transmission equipment can be used to communicate with one or more processing devices, such as a downhole electronics unit 32 and/or a surface processing unit 34. The processing device or devices include various electronic components to facilitate receiving signals and collecting data, transmitting data and commands, and/or controlling one or more aspects of an energy industry operation such as an LWD operation.

For example, the processing unit 34 includes an input/output device 36, a processor 38, and a data storage device 40 (e.g., memory, computer-readable media, etc.) for storing data 42 such as measurement data, models, T₂ distributions, fracture data and others. The data storage device 40 also stores computer programs or software 44 that cause the processor to perform aspects of methods and processes described herein. The surface processing unit 34 (and/or the downhole electronics unit 32) may be configured to perform functions such as controlling drilling and steering, controlling the pumping of borehole fluid and/or cement injection, transmitting and receiving data, processing measurement data, and/or monitoring operations of the system 10. As discussed further below, the processing unit 34 and/or an operator can control operational parameters such as drilling direction and fluid flow, and may also facilitate planning other operations, such as production and hydraulic fracturing operations. For example, the surface processing unit 34 is configured as a surface control unit which controls various parameters such as rotary speed, weight-on-bit, fluid flow parameters (e.g., pressure and flow rate) and others.

Magnetic resonance measurements are performed by the NMR tool 18, which generates a static magnetic field (B₀) in a volume or region within the formation (a “region of interest”) using one or more magnets (e.g., the magnetic field source 24). An oscillating magnetic field (B₁) is generated, which is at least substantially perpendicular to the static magnetic field in the volume of interest. The region of interest may be circular or toroidal around the borehole, and/or focused or directed toward a specific angular region (i.e., side-looking).

When exposed to the magnetic field B₀, the spin axes of hydrogen nuclei in the formation precess around the direction of the B₀ field with the Larmor frequency, which is proportional to the strength of the magnetic field B₀. Over time, the spin axes align themselves at distinct angles along the B₀ field and create a net magnetization (i.e., polarization), which will build up with the time constant T₁, referred to as a longitudinal relaxation or spin lattice relaxation time. T₂ is a time constant of the transversal relaxation, which describes the loss of magnetization in the plane orthogonal to the B₀ field.

The surface processing unit 34, electronics unit 32 and/or other suitable processing device includes a processor configured to perform NMR measurements of a region or volume of interest in a formation and/or estimate fracture properties of the formation based on the NMR measurements.

Although the system 10 is shown as including a drill string, it is not so limited and may have any configuration suitable for performing an energy industry operation. For example, the system 10 may be configured as a hydraulic stimulation system. Another example includes a production system including a production string and flow control devices such as inflow control valves.

Systems and/or processors described herein (e.g., the surface processing unit 34) are configured to evaluate fracture properties of an earth formation based on NMR measurements. In one embodiment, the surface processing unit 34 is configured to perform a method that includes receiving NMR measurement data (e.g., echo train data), estimating a T₂ distribution, and estimating pore size and fracture aperture properties of a formation or formation region. Although the methods described herein are discussed as being performed by a processor or processing device, the methods are not so limited. For example, one or more aspects of the methods may be performed by a human operator or performed by a human operator in conjunction with the processor.

In one embodiment, the system 10 and/or a processor are configured to evaluate fracture properties of tight rock formations. Such evaluation includes, in one embodiment, calculation or estimation of the aperture size of fractures based on NMR T₂ logs. Such fractures may include naturally occurring fractures and/or induced or stimulated fractures such as fractures formed or extended by hydraulic fracturing. The stimulated fractures may be fractures that are stimulated by the current operation or by previous operations. A “natural fracture” refers to a fracture in a formation that has not been created, opened or otherwise affected by an energy industry operation.

Fractured reservoir layers can be indicators of potential “sweet spots,” which are regions or zones that exhibit characteristics associated with a high potential for hydrocarbon production. Estimation of fracture properties, such as fracture aperture and fracture distribution, according to embodiments described herein may be used to identify sweet spots or otherwise evaluate a formation or formation region.

NMR T₂ spectra include relaxation responses of the intragranular and intergranular pores (organic and inorganic), fractures, and laminations of a formation or zone. In one embodiment, NMR data is processed and analyzed to derive an NMR T₂ relaxation distribution (also referred to simply as a “T₂ distribution”), and calculate the aperture size of one or more fractures in a tight rock formation based on the T₂ distribution. In one embodiment, the T₂ distribution is calibrated or otherwise analyzed to generate a pore size distribution, and an aperture size distribution is estimated based on the pore size distribution, as discussed further below.

In one embodiment, generating the pore size distribution includes dividing or separating a T₂ distribution into two or more portions. Such portions may be referred to as volume fractions, or fractions of the pore space volume. Each volume fraction is associated with a T₂ value range. The T₂ distribution is separated using a cut-off time that separates the T₂ distribution into two portions that correspond with two volumetrics: a first volumetric or volume fraction associated with responses of pores and the formation matrix, and a second volumetric or volume fraction associated with response of fractures in the formation or zone.

The T₂ values below the cut-off time (i.e., associated with times prior to the cut-off time) hold the responses of the matrix and/or pores, and the T₂ values above the cut-off time (i.e., associated with times after to the cut-off time) hold the response of the fractures. In tight rocks, since the size of the pores and the fractures are comparable, the pore size distribution can be transformed into a fracture size distribution within the formation region associated with the slowest relaxation.

In tight rocks, it is recognized that the surfaces of the pores therein primarily control NMR relaxation, which allows for the calculation of pore size distributions. The decay of T₂ relaxation over time, represented by a T₂ spectrum, can be written as shown in Equation (1):

$$\frac{1}{{T}_{2}} = \frac{1}{{T}_{2 , bulk}} + \frac{1}{{T}_{2 , diffusion}} + \frac{1}{{T}_{2 , surface}} . \qquad ( 1 )$$

T_{2,diffuision} is the relaxation rate due to diffusion in the magnetic field gradient. T_{2,bulk} is the relaxation rate due to bulk fluid, and T_{2,surface} is the rate of relaxation that occurs at pore surfaces, i.e., the surface relaxation.

Methods described herein are based on the recognition that, in tight rocks, the surface relaxation dominates NMR dynamics because the bulk relaxation is very slow and the diffusion is in the fast regime. Hence, the general NMR relaxation described by Equation (1) can be reduced to surface relaxation as shown in Equation (2):

$$\frac{1}{{T}_{2}} = \frac{1}{{T}_{2 , surface}} = {ρ}_{2} \frac{S}{V} . \qquad ( 2 )$$

ρ₂ is the surface relaxivity, S is the surface area of pores in a formation region, V is the volume of the pores, and S/V is a surface-to-volume ratio of the pores. Equation (2) establishes a direct correlation between NMR T₂ measurements and the pore space characterization in any tight rock.

The pore space can be characterized by properties such as pore size distribution and fracture aperture distribution. For example, in the case of spherical pores having a diameter d, the surface-to-volume ratio is given by Equation (3):

$$\frac{S}{V} = {( \frac{6}{d} )}_{pores} . \qquad ( 3 )$$

If the fractures are planar (or assumed to be planar) and have an average aperture w, the surface-to-volume ratio is given by Equation (4):

$$\frac{S}{V} = {( \frac{2}{w} )}_{fractures} . \qquad ( 4 )$$

From Equations (3) and (4), a direct relation between the fracture aperture and the pore diameter can be derived. This relation is expressed as:

$$w = \frac{d}{3} \qquad ( 5 )$$

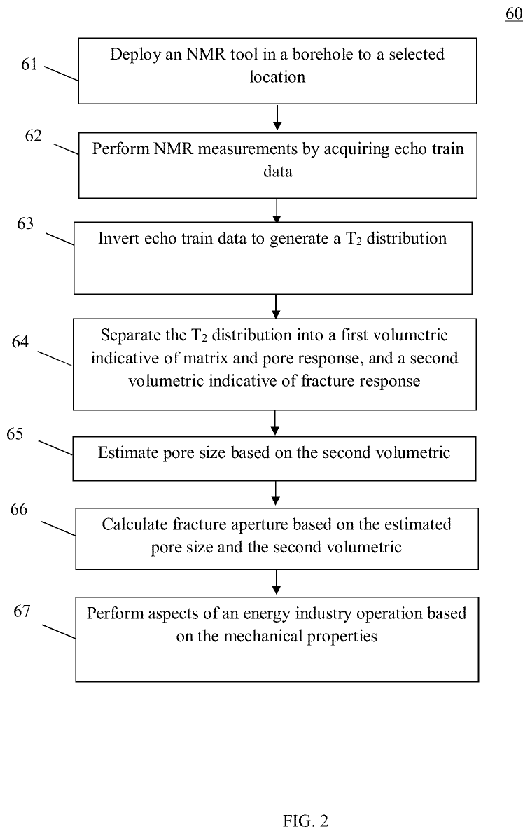

FIG. 2 illustrates a method 60 of performing NMR measurements and estimating fracture properties of a formation. The method 60 may be performed in conjunction with the system 10, but is not limited thereto. The method 60 includes one or more of stages 61-67 described herein, at least portions of which may be performed by a processor (e.g., the surface processing unit 28). In one embodiment, the method 60 includes the execution of all of stages 61-67 in the order described. However, certain stages may be omitted, stages may be added, or the order of the stages changed.

The method 60 is described in conjunction with the system 10 of FIG. 1, but is not so limited. The method 60 may be used with any device or system that performs NMR measurements and/or receives NMR measurement data.

In the first stage 61, the NMR tool 18 or other magnetic resonance measurement tool is deployed into a borehole to a selected location. In one embodiment, the NMR tool 18 is deployed as part of a wireline operation, or during drilling as part of an LWD operation. The speed at which the NMR tool 18 is advanced is referred to as logging speed.

In the second stage 62, when the NMR tool 18 is located at the selected location, NMR measurements are performed by generating a static magnetic field B₀ in a volume or region of interest around the selected location (a formation or formation region), and transmitting pulsed signals from at least one transmitting antenna into the region of interest. At least one receiving antenna detects NMR signals from the region of interest in response to the interaction between the nuclear spins of interest and the static and oscillating magnetic fields, and generates NMR measurement data. The NMR measurement data includes spin echo trains that may be measured at a plurality of depths or locations.

The NMR signals, in one embodiment, are detected as time domain amplitude measurements generated by each pulse sequence. The time domain amplitude values for a pulse sequence are referred to as an echo train, in which the echo amplitude decreases with the time constant T₂.

In one embodiment, the region of interest includes or is a tight rock region or region of a tight rock formation. A tight rock formation is a formation that has a relatively low permeability and/or porosity. The low permeability of a tight rock formation may be due to small grains (matrix) located between larger grains in the rock, resulting in a low porosity. For example, pore sizes in tight rocks can be as low as 2 μm. In one embodiment, a tight rock formation is a formation having a porosity that is less than or equal to 5 porosity units (p.u.) or 5% of the total volume of the rock. Examples of tight rock formations include sedimentary rock formations such as sandstone, shale and shale oil formations. It is noted that the method 60 is not limited to the types of formations discussed herein, but may be used in conjunction with any type of low permeability and/or low porosity formation.

In the third stage 63, the NMR measurement data including raw time domain echo trains are processed to calculate a measured T₂ distribution by inverting the echo train data into the T₂ domain.

In the fourth stage 64, the T₂ distribution is divided into two or more portions or volume fractions. Each volume fraction is associated with a T₂ value range. To divide the T₂ distribution, a T₂ cut-off time is selected that separates the response of the matrix and/or pores from the response of the fractures. The cut-off time may be calculated, selected or derived in a number of ways.

In one embodiment, the cut-off time is selected based on a selected maximum pore size or upper pore size limit, and a selected maximum surface relaxivity or upper surface relaxivity limit for the region. The maximum pore size and the maximum surface relaxivity may be acquired by core measurements, downhole measurements, data from previous operations and/or pre-existing knowledge regarding the tight rock formation associated with the region of interest.

In one embodiment, for a tight rock formation, the maximum pore size is a maximum pore diameter. For example, the maximum pore diameter is selected as d=2000 nm, and the maximum surface relaxivity is selected as ρ₂=10 μm/s. From these values, a cut-off time is calculated (e.g., using Equations (2) and (3)) as about 33 milliseconds (ms).

The cut-off time is used to divide the T₂ distribution into a first portion or volumetric indicative of pore and/or matrix response, and a second portion or volumetric indicative of fracture response. In the above example, T₂ values below the cut-off time of about 33 ms make up the first portion, and T₂ values above the cut-off time make up the second portion.

In the fifth stage 65, pore size is estimated from the second portion, e.g., by calibrating the second portion. In one embodiment, a pore size distribution is calculated from the second portion. Pore size can be calculated by, e.g., fitting the second T₂ portion to one or more functions associated with known pore sizes or diameters.

In the sixth stage 66, fracture aperture size is calculated based on the estimated pore size distribution. In one embodiment, a fracture aperture size distribution is calculated based on a direct correlation between pore size and fracture aperture derived at least from Equation (2). For example, a fracture aperture size distribution is calculated from the pore size distribution using Equations (2)-(4).

The fracture aperture size distribution may be utilized in various ways. Aperture size data can be used to evaluate energy industry operations and/or plan subsequent energy industry operations, such as drilling, production and stimulation operations. For example, the fracture aperture size distribution can be analyzed to evaluate the effectiveness of previous hydraulic fracturing operations. In another example, drilling parameters such as drilling direction and flow rate can be selected as part of a planning phase.

In the seventh stage 67, aspects of an energy industry operation are performed based on the fracture aperture size data (e.g., the fracture aperture size distribution). Examples of energy industry operations include drilling, stimulation, formation evaluation, measurement and/or production operations. For example, the fracture aperture size distribution is used to plan a drilling operation (e.g., trajectory, bit and equipment type, mud composition, rate of penetration, etc.) and may also be used to monitor the operation in real time and adjust operational parameters (e.g., bit rotational speed, fluid flow).

In addition, the fracture aperture data can be applied to various operations, and used to perform periodic and/or real time monitoring. For example, the method 60 can be performed to provide real time assessment of reservoir quality. The method 60 can be utilized for continuous monitoring of fracture properties, e.g., in reservoir stimulation and hydraulic fracturing applications. For example, embodiments described herein can be used to generate a continuous log of rock structural properties including fracture sizes, during or after LWD, wireline and other operations.

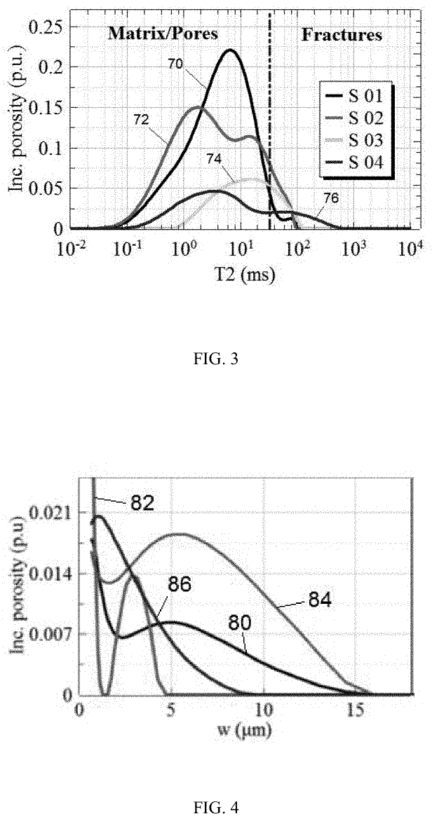

An example of the method 60 is discussed in conjunction with FIGS. 3 and 4 to demonstrate the efficacy of the above method. FIG. 3 illustrates an example of T₂ distributions calculated from NMR echo train measurements. FIG. 4 shows an example of fracture aperture size distributions calculated based on the T₂ distributions of FIG. 3.

In this example, NMR measurements were performed on four rock samples after spontaneous imbibition of oil. The NMR measurements were processed and inverted to T₂ distributions of incremental porosity in porosity units (p.u.) as a function of T₂. A first T₂ distribution 70 corresponds to a first sample, a second T₂ distribution 72 corresponds to a second sample, a third T₂ distribution 74 corresponds to a third sample, and a fourth T₂ distribution 76 corresponds to a fourth sample.

Each T₂ distribution was divided into a T₂ volumetric above a cut-off time that was selected based on a maximum pore size and a maximum relaxivity. In this example, a cut-off time of about 33 ms was derived based on a maximum pore diameter d of 2000 nm and a maximum surface relaxivity ρ₂ of 10 μm/s.

The T₂ volumetrics above the cut-off time were used to calculate corresponding fracture aperture values as a function of incremental porosity. FIG. 4 shows the resultant fracture aperture distributions. A first fracture aperture distribution 80 corresponds to the first T₂ distribution 70, a second fracture aperture distribution 82 corresponds to the second T₂ distribution 72, a third fracture aperture distribution 84 corresponds to the third T₂ distribution 74, and a fourth fracture aperture distribution 86 corresponds to the fourth T₂ distribution 76.

Embodiments described herein may be utilized to assess reservoir quality and optimize production. Fractures play a major role in assessing the quality of hydrocarbon reservoirs where they are identified as indicators of sweet spots. The fractures connect the different compartments of the pore space, including the isolated porosity or vugs, which increases the effective porosity and enhances. Identification and evaluation of fractures as described herein can be effective in increasing and/or optimizing reservoir production.

Set forth below are some embodiments of the foregoing disclosure:

Embodiment 1: An apparatus for estimating fracture properties of a resource bearing formation, the apparatus comprising: a nuclear magnetic resonance (NMR) measurement device configured to be deployed in a region of interest, the region of interest including a tight rock formation region, the NMR measurement device including a transmitting assembly configured to transmit an NMR pulse sequence into the tight rock formation region, and a receiving assembly configured to detect NMR signals corresponding to a response of the tight rock formation region to the pulse sequence; and a processor configured to receive the NMR signals and perform: inverting the NMR signals into a transverse relaxation time (T₂) distribution; separating the T₂ distribution based on a cut-off time into a first volumetric indicative of matrix and pore responses and a second volumetric indicative of fracture responses; estimating a pore size distribution based on the second volumetric; and calculating a fracture aperture size distribution based on the pore diameter.

Embodiment 2: The apparatus as in any prior embodiment, wherein the processor is configured to perform one or more aspects of an energy industry operation based on the fracture aperture size distribution.

Embodiment 3: The apparatus as in any prior embodiment, wherein the cut-off time is determined based on a maximum pore size and a largest surface relaxivity of the tight rock formation region.

Embodiment 4: The apparatus as in any prior embodiment, wherein the fracture aperture size distribution is estimated based on a direct correlation between pore diameter and fracture aperture size.

Embodiment 5: The apparatus as in any prior embodiment, wherein the direct correlation is based on an assumption that the response of the tight rock formation region is at least substantially a result of surface relaxation, and the response is represented by:

$$\frac{1}{{T}_{2}} = \frac{1}{{T}_{2 , surface}} ,$$

wherein T_{2,surface} is a relaxation time associated with the surface relaxation, and:

$$\frac{1}{{T}_{2 , surface}} = {ρ}_{2} \frac{S}{V} ,$$

wherein ρ2 is a surface relaxivity, S is a surface area of pores in the tight rock formation region, V is a volume of the pores, and S/V is a surface-to-volume ratio of the pores.

Embodiment 6: The apparatus as in any prior embodiment, wherein the direct correlation is based on a relationship between the pore diameter and the surface-to-volume ratio, and a relationship between the fracture aperture size and the surface-to-volume ratio.

Embodiment 7: The apparatus as in any prior embodiment, wherein the direct correlation is based on an assumption that the tight rock formation region includes spherical pores having a diameter d, and that fractures in the tight rock formation region are planar fractures having an average aperture size w.

Embodiment 8: The apparatus as in any prior embodiment, wherein the direct correlation is represented by:

$$w = \frac{d}{3} .$$

Embodiment 9: The apparatus as in any prior embodiment, wherein the NMR measurement device is incorporated into a wireline logging assembly or a logging-while-drilling (LWD) assembly.

Embodiment 10: The apparatus as in any prior embodiment, wherein the processor is configured to calculate the fracture aperture size distribution in real time and provide a real time assessment of productivity of the tight rock formation region.

Embodiment 11: A method of estimating fracture properties of a resource bearing formation, the method including: receiving, by a processor, NMR signals generated by a nuclear magnetic resonance (NMR) measurement device deployed in a region of interest, the region of interest including a tight rock formation region, the NMR measurement device including a transmitting assembly configured to transmit an NMR pulse sequence into the tight rock formation region, and a receiving assembly configured to detect NMR signals corresponding to a response of the tight rock formation region to the pulse sequence; and inverting the NMR signals into a transverse relaxation time (T₂) distribution; separating the T₂ distribution based on a cut-off time into a first volumetric indicative of matrix and pore responses and a second volumetric indicative of fracture responses; estimating a pore size distribution based on the second volumetric; and calculating a fracture aperture size distribution based on the pore diameter.

Embodiment 12: The method as in any prior embodiment, further comprising performing one or more aspects of an energy industry operation based on the fracture aperture size distribution.

Embodiment 13: The method as in any prior embodiment, wherein the cut-off time is determined based on a maximum pore size and a largest surface relaxivity of the tight rock formation region.

Embodiment 14: The method as in any prior embodiment, wherein the fracture aperture size distribution is estimated based on a direct correlation between pore diameter and fracture aperture size.

Embodiment 15: The method as in any prior embodiment, wherein the direct correlation is based on an assumption that the response of the tight rock formation region is at least substantially a result of surface relaxation, and the response is represented by:

$$\frac{1}{{T}_{2}} = \frac{1}{{T}_{2 , surface}} ,$$

wherein T_{2,surface} wave is a relaxation time associated with the surface relaxation, and:

$$\frac{1}{{T}_{2 , surface}} = {ρ}_{2} \frac{S}{V} ,$$

wherein ρ2 is a surface relaxivity, S is a surface area of pores in the tight rock formation region, V is a volume of the pores, and S/V is a surface-to-volume ratio of the pores.

Embodiment 16: The method as in any prior embodiment, wherein the direct correlation is based on a relationship between the pore diameter and the surface-to-volume ratio, and a relationship between the fracture aperture size and the surface-to-volume ratio.

Embodiment 17: The method as in any prior embodiment, wherein the direct correlation is based on an assumption that the tight rock formation region includes spherical pores having a diameter d, and that fractures in the tight rock formation region are planar fractures having an average aperture size w.

Embodiment 18: The method as in any prior embodiment, wherein the direct correlation is represented by:

$$w = \frac{d}{3} .$$

Embodiment 19: The method as in any prior embodiment, wherein the NMR measurement device is incorporated into a wireline logging assembly or a logging-while-drilling (LWD) assembly.

Embodiment 20: The method as in any prior embodiment, wherein the fracture aperture size distribution is calculated in real time and the method further comprises providing a real time assessment of productivity of the tight rock formation region.

In connection with the teachings herein, various analyses and/or analytical components may be used, including digital and/or analog subsystems. The system may have components such as a processor, storage media, memory, input, output, communications link (wired, wireless, pulsed mud, optical or other), user interfaces, software programs, signal processors and other such components (such as resistors, capacitors, inductors, etc.) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user, or other such personnel, in addition to the functions described in this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention.

What is claimed is:

1. An apparatus for estimating fracture properties of a resource bearing formation, the apparatus comprising:
a nuclear magnetic resonance (NMR) measurement device configured to be deployed in a region of interest, the region of interest including a tight rock formation region, the NMR measurement device including a transmitting assembly configured to transmit an NMR pulse sequence into the tight rock formation region, and a receiving assembly configured to detect NMR signals corresponding to a response of the tight rock formation region to the pulse sequence; and
a processor configured to receive the NMR signals and perform:
inverting the NMR signals into a transverse relaxation time (T₂) distribution;
separating the T₂ distribution based on a cut-off time into a first volumetric indicative of matrix and pore responses and a second volumetric indicative of fracture responses;
estimating a pore size distribution based on the second volumetric; and
calculating a fracture aperture size distribution based on the pore diameter.

2. The apparatus of claim 1, wherein the processor is configured to perform one or more aspects of an energy industry operation based on the fracture aperture size distribution.

3. The apparatus of claim 1, wherein the cut-off time is determined based on a maximum pore size and a largest surface relaxivity of the tight rock formation region.

4. The apparatus of claim 1, wherein the fracture aperture size distribution is estimated based on a direct correlation between pore diameter and fracture aperture size.

5. The apparatus of claim 4, wherein the direct correlation is based on an assumption that the response of the tight rock formation region is at least substantially a result of surface relaxation, and the response is represented by:
$$\frac{1}{{T}_{2}} = \frac{1}{{T}_{2 , surface}} ,$$
wherein T_{2,surface} is a relaxation time associated with the surface relaxation, and:
$$\frac{1}{{T}_{2 , surface}} = {ρ}_{2} \frac{S}{V} ,$$
wherein ρ2 is a surface relaxivity, S is a surface area of pores in the tight rock formation region, V is a volume of the pores, and S/V is a surface-to-volume ratio of the pores.

6. The apparatus of claim 5, wherein the direct correlation is based on a relationship between the pore diameter and the surface-to-volume ratio, and a relationship between the fracture aperture size and the surface-to-volume ratio.

7. The apparatus of claim 6, wherein the direct correlation is based on an assumption that the tight rock formation region includes spherical pores having a diameter d, and that fractures in the tight rock formation region are planar fractures having an average aperture size w.

8. The apparatus of claim 7, wherein the direct correlation is represented by:
$$w = \frac{d}{3} .$$

9. The apparatus of claim 1, wherein the NMR measurement device is incorporated into a wireline logging assembly or a logging-while-drilling (LWD) assembly.

10. The apparatus of claim 1, wherein the processor is configured to calculate the fracture aperture size distribution in real time and provide a real time assessment of productivity of the tight rock formation region.

11. A method of estimating fracture properties of a resource bearing formation, the method comprising:
receiving, by a processor, NMR signals generated by a nuclear magnetic resonance (NMR) measurement device deployed in a region of interest, the region of interest including a tight rock formation region, the NMR measurement device including a transmitting assembly configured to transmit an NMR pulse sequence into the tight rock formation region, and a receiving assembly configured to detect NMR signals corresponding to a response of the tight rock formation region to the pulse sequence; and
inverting the NMR signals into a transverse relaxation time (T₂) distribution;
separating the T₂ distribution based on a cut-off time into a first volumetric indicative of matrix and pore responses and a second volumetric indicative of fracture responses;
estimating a pore size distribution based on the second volumetric; and
calculating a fracture aperture size distribution based on the pore diameter.

12. The method of claim 11, further comprising performing one or more aspects of an energy industry operation based on the fracture aperture size distribution.

13. The method of claim 11, wherein the cut-off time is determined based on a maximum pore size and a largest surface relaxivity of the tight rock formation region.

14. The method of claim 11, wherein the fracture aperture size distribution is estimated based on a direct correlation between pore diameter and fracture aperture size.

15. The method of claim 14, wherein the direct correlation is based on an assumption that the response of the tight rock formation region is at least substantially a result of surface relaxation, and the response is represented by:
$$\frac{1}{{T}_{2}} = \frac{1}{{T}_{2 , surface}} ,$$
wherein T_{2,surface} is a relaxation time associated with the surface relaxation, and:
$$\frac{1}{{T}_{2 , surface}} = {ρ}_{2} \frac{S}{V} ,$$
wherein ρ2 is a surface relaxivity, S is a surface area of pores in the tight rock formation region, V is a volume of the pores, and S/V is a surface-to-volume ratio of the pores.

16. The method of claim 15, wherein the direct correlation is based on a relationship between the pore diameter and the surface-to-volume ratio, and a relationship between the fracture aperture size and the surface-to-volume ratio.

17. The method of claim 16, wherein the direct correlation is based on an assumption that the tight rock formation region includes spherical pores having a diameter d, and that fractures in the tight rock formation region are planar fractures having an average aperture size w.

18. The method of claim 17, wherein the direct correlation is represented by:
$$w = \frac{d}{3} .$$

19. The method of claim 11, wherein the NMR measurement device is incorporated into a wireline logging assembly or a logging-while-drilling (LWD) assembly.

20. The method of claim 11, wherein the fracture aperture size distribution is calculated in real time and the method further comprises providing a real time assessment of productivity of the tight rock formation region.
